(19) United States
(12) Patent Application Publication
(10) Pub. No.: US 2026/0183870 A1
(43) Pub. Date: Jul. 2, 2026

(54) In-Situ Nanoparticle-Reinforced Aluminum-Based Welding Wire, and Preparation Method and Welding Method Thereof

(71) Applicant: Jiangsu University, Jiangsu (CN)

(72) Inventors: Yutao Zhao, Jiangsu (CN); Xu Gao, Jiangsu (CN); Xizhou Kai, Jiangsu (CN); Kelun Sun, Jiangsu (CN); Hanfei Zhu, Jiangsu (CN)

(21) Appl. No.: 18/727,711

(22) PCT Filed: Oct. 23, 2023
(86) PCT No.: PCT/CN2023/125818

§ 371 Date: Jul. 10, 2024

(30) Foreign Application Priority Data
Jul. 13, 2023 (CN) 202310861204.3

(51) Int. Cl. B23K 26/346; B23K 35/02; B23K 35/28; B23K 35/36; B23K 103/10

(52) U.S. Cl. CPC B23K 26/346; B23K 35/0266; B23K 35/288; B23K 35/3606; B23K 35/3608; B23K 2103/10

(57) ABSTRACT

Provided are an in-situ nanoparticle-reinforced aluminum-based welding wire, and a preparation method and a welding method thereof. The aluminum-based welding wire includes a flux core, a coating, and a protective layer that are arranged in sequence from inside to outside.

### CROSS-REFERENCE TO RELATED APPLICATION

The present application is a national stage application of International Patent Application No. PCT/CN2023/125818, filed on Oct. 23, 2023, which claims priority to a Chinese Patent Application No. 2023108612043, entitled “IN-SITU NANOPARTICLE-REINFORCED ALUMINUM-BASED WELDING WIRE, AND PREPARATION METHOD AND WELDING METHOD THEREOF” filed with the China National Intellectual Property Administration (CNIPA) on Jul. 13, 2023. The disclosure of the two applications is incorporated herein by reference in its entirety.

### TECHNICAL FIELD

The present disclosure relates to the technical field of welding wires, and in particular relates to an in-situ nanoparticle-reinforced aluminum-based welding wire, and a preparation method and a welding method thereof.

### BACKGROUND

Aluminum alloy has the characteristics of low density, high strength, and desirable fatigue resistance, and is widely used in automobile manufacturing, aerospace and other fields. In the new century, key structural components in the automobile manufacturing, the aerospace and other fields are required to meet demands such as lightweight, toughness, large-scale, and high reliability, and improving weldability of the key structural components has become a research hotspot. The difficulty in welding 6XXX or 7XXX series aluminum alloys is partly caused by high sensitivity of the 6XXX or 7XXX series aluminum alloys to hot cracks. In addition, dissolution and coarsening of precipitated phases during welding thermal cycle would greatly reduce the mechanical properties of aluminum alloy welded plates.

Therefore, it has become an urgent problem to be solved in this field to improve the welding performance of aluminum-based welding wires and thereby improve the mechanical properties of the welded plates.

### SUMMARY

The present disclosure is to provide an in-situ nanoparticle-reinforced aluminum-based welding wire, and a preparation method and a welding method thereof. In the present disclosure, the in-situ nanoparticle-reinforced aluminum-based welding wire has excellent welding performance, such that a resulting welded plate could achieve excellent mechanical properties.

To achieve the above objects, the present disclosure provides the following technical solutions:

The present disclosure provides an in-situ nanoparticle-reinforced aluminum-based welding wire, including a flux core, a coating, and a protective layer that are arranged in sequence from inside to outside; where
the flux core includes the following components in mass percentage: 1.7% to 8.1% of B₂O₃, 1.0% to 5.4% of ZrO₂, 1.1% to 5.7% of TiO₂, 0.1% to 1.0% of a powder, 0.8% to 1.2% of Mg, 0.4% to 1.2% of Si, 0.1% to 0.4% of Cu, 0.04% to 0.35% of Cr, 0.15% to 0.25% of Zn, and an aluminum powder as a balance; alternatively,
the flux core includes the following components in mass percentage: 1.7% to 8.1% of B₂O₃, 1.0% to 5.4% of ZrO₂, 1.1% to 5.7% of TiO₂, 0.1% to 1.0% of a powder, 4.0% to 8.0% of Zn, 1.0% to 3.5% of Mg, 0% to 2.5% of Cu, and an aluminum powder as a balance; and
the powder is at least one selected from the group consisting of Sc, Er, and Zr.

In some embodiments, the flux core includes the following components in mass percentage: 2.0% to 8.0% of the B₂O₃, 1.1% to 5.0% of the ZrO₂, 1.1% to 5.0% of the TiO₂, 0.3% to 1.0% of the powder, 1.0% to 1.2% of the Mg, 0.6% to 1.0% of the Si, 0.1% to 0.2% of the Cu, 0.1% to 0.30% of the Cr, 0.20% to 0.25% of the Zn, and the aluminum powder as a balance.

In some embodiments, the flux core includes the following components in mass percentage: 2.0% to 8.1% of the B₂O₃, 1.1% to 5.4% of the ZrO₂, 1.5% to 5.0% of the TiO₂, 0.45% to 0.6% of the powder, 1.6% to 2.4% of the Mg, 1.4% to 2.0% of the Cu, 6.0% to 7.6% of the Zn, and the aluminum powder as a balance.

In some embodiments, the powder is selected from the group consisting of a mixed powder of the Sc and the Zr, and a mixed powder of the Er and the Zr.

In some embodiments, a mass ratio of the Sc to the Zr in the mixed powder of the Sc and the Zr is 1:2; and a mass ratio of the Er to the Zr in the mixed powder of the Er and the Zr is 2:1.

In some embodiments, the flux core has a filling rate of 5% to 34%.

In some embodiments, the coating is prepared by using a 1070 semi-hard pure aluminum strip.

In some embodiments, the coating has a thickness of 0.1 mm to 0.2 mm.

In some embodiments, the protective layer is composed of SiC and Al₂O₃.

In some embodiments, a mass ratio of the SiC to the Al₂O₃ is in a range of 3:1 to 3:2.

In some embodiments, the protective layer has a thickness of 0.1 mm to 0.2 mm.

The present disclosure further provides a method for preparing the in-situ nanoparticle-reinforced aluminum-based welding wire described in the above technical solutions, including the following steps:
(1) rolling the coating into a U-shaped groove, filling the U-shaped groove with the flux core, and then sealing the U-shaped groove to obtain a semi-finished product; and
(2) coating the protective layer on an outer layer of the semi-finished product obtained in step (1), and then conducting wire drawing to obtain the in-situ nanoparticle-reinforced aluminum-based welding wire.

The present disclosure further provides a welding method of the in-situ nanoparticle-reinforced aluminum-based welding wire described in the above technical solutions or an in-situ nanoparticle-reinforced aluminum-based welding wire prepared by the method described in the above technical solution, including conducting laser welding assisted by a microwave, dual magnetic fields, and an ultrasonic field simultaneously.

In some embodiments, the microwave has an output frequency of 2.45 GHz and an output power of 0 kW to 3 kW.

In some embodiments, the dual magnetic fields are an alternating magnetic field and a constant magnetic field; the alternating magnetic field has an exciting current of 250 A to 300 A and a frequency of 10 Hz to 12 Hz; and the constant magnetic field has a magnetic field intensity of 0.1 T to 0.3 T.

In some embodiments, the ultrasonic field has an ultrasonic power of 5 kW to 10 kW and an ultrasonic frequency of 20 kHz to 30 kHz.

The present disclosure provides an in-situ nanoparticle-reinforced aluminum-based welding wire, including a flux core, a coating, and a protective layer that are arranged in sequence from inside to outside; where the flux core includes the following components in mass percentage: 1.7% to 8.1% of B₂O₃, 1.0% to 5.4% of ZrO₂, 1.1% to 5.7% of TiO₂, 0.1% to 1.0% of a powder, 0.8% to 1.2% of Mg, 0.4% to 1.2% of Si, 0.1% to 0.4% of Cu, 0.04% to 0.35% of Cr, 0.15% to 0.25% of Zn, and an aluminum powder as a balance; alternatively, the flux core includes the following components in mass percentage: 1.7% to 8.1% of B₂O₃, 1.0% to 5.4% of ZrO₂, 1.1% to 5.7% of TiO₂, 0.1% to 1.0% of a powder, 4.0% to 8.0% of Zn, 1.0% to 3.5% of Mg, 0% to 2.5% of Cu, and an aluminum powder as a balance; and the powder is at least one selected from the group consisting of Sc, Er, and Zr. In the present disclosure, the aluminum-based welding wire is suitable for high-temperature welding. Under a high temperature condition of welding, ceramic powder components B₂O₃, ZrO₂, and TiO₂ in the flux core react in situ with a metal powder in a weldment to generate ternary nano-ceramic particles of ZrB₂, TiB₂, and Al₂O₃. The TiB₂ and ZrB₂ are hexagonal metalloid compounds with excellent thermodynamic stability, high melting point and elastic modulus, and desirable high-temperature strength. Al₂O₃ particles are very stable in size, have high hardness and desirable chemical compatibility with a matrix, and do not undergo interfacial chemical reactions. Multi-component nanoparticle reinforcement phases interact with each other and have a synergistic effect. The multi-component nanoparticles are more refined and strengthened than single nanoparticles. Meanwhile, the ZrB₂, the TiB₂, and the Al₂O₃ are desirable high-temperature absorption materials, and could generate active sites on surfaces of the ceramic particles during the welding, making it easier for Sc, Er, and Zr that have desirable wettability with aluminum to adhere to the surfaces of the ceramic particles, thereby improving the wettability between the nano-ceramic particles and aluminum to obtain more uniformly-distributed nanoparticles. In addition, rare earth aluminide phases could also significantly refine and strengthen a weld joint, thereby improving welding performance of the wire and in turn making obtained welded plates achieve excellent mechanical properties. Experimental results show that a welded joint obtained by using the in-situ nanoparticle-reinforced aluminum-based welding wire provided in the present disclosure has a tensile strength of 323 MPa to 452 MPa, an elongation of 11.5% to 15.3%, and a joint coefficient of 76% to 88%.

### BRIEF DESCRIPTION OF THE DRAWINGS

FIG. 1 shows a schematic structural diagram of a device for laser welding assisted by a microwave, dual magnetic fields, and an ultrasonic field simultaneously in an embodiment of the present disclosure; where
1 refers to a microwave generator, 2 refers to an alternating electromagnetic field power supply, 3 refers to a constant electromagnetic field power supply, 4 refers to an ultrasonic transmitter, 5 refers to a laser welded joint, 6 refers to a microwave transmitter, 7 refers to an alternating electromagnetic field coil, 8 refers to a magnetic field isolation plate, 9 refers to a constant electromagnetic field coil, 10 refers to an in-situ nanoparticle-reinforced aluminum-based welding wire, 11 refers to a welded plate, and 12 refers to an ultrasonic horn;

FIG. 2 shows an optical microscope (OM) image of the weld joint prepared in Use Example 4; and

FIG. 3 shows a scanning electron microscopy (SEM) image of the weld joint prepared in Use Example 4.

### DETAILED DESCRIPTION OF THE EMBODIMENTS

The present disclosure provides an in-situ nanoparticle-reinforced aluminum-based welding wire, including a flux core, a coating, and a protective layer that are arranged in sequence from inside to outside; where
the flux core includes the following components in mass percentage: 1.7% to 8.1% of B₂O₃, 1.0% to 5.4% of ZrO₂, 1.1% to 5.7% of TiO₂, 0.1% to 1.0% of a powder, 0.8% to 1.2% of Mg, 0.4% to 1.2% of Si, 0.1% to 0.4% of Cu, 0.04% to 0.35% of Cr, 0.15% to 0.25% of Zn, and an aluminum powder as a balance; alternatively,
the flux core includes the following components in mass percentage: 1.7% to 8.1% of B₂O₃, 1.0% to 5.4% of ZrO₂, 1.1% to 5.7% of TiO₂, 0.1% to 1.0% of a powder, 4.0% to 8.0% of Zn, 1.0% to 3.5% of Mg, 0% to 2.5% of Cu, and an aluminum powder as a balance; and
the powder is at least one selected from the group consisting of Sc, Er, and Zr.

In the present disclosure, the in-situ nanoparticle-reinforced aluminum-based welding wire includes a flux core.

In a technical solution of the present disclosure, the flux core includes the following components in mass percentage: 1.7% to 8.1% of B₂O₃, 1.0% to 5.4% of ZrO₂, 1.1% to 5.7% of TiO₂, 0.1% to 1.0% of a powder, 0.8% to 1.2% of Mg, 0.4% to 1.2% of Si, 0.1% to 0.4% of Cu, 0.04% to 0.35% of Cr, 0.15% to 0.25% of Zn, and an aluminum powder as a balance. A welding wire made of the flux core provided by the present disclosure is suitable for welding the base metal of 6XXX series aluminum alloys in the field of automobile manufacturing.

In some embodiments of the present disclosure, the flux core includes, in mass percentage, 1.7% to 8.1%, preferably 2.0% to 8.0%, more preferably 3.0% to 7.0%, and even more preferably 4.0% to 5.0% of the B₂O₃. In the present disclosure, the B₂O₃ could react in situ with a metal powder in a weldment during welding to generate nano-ceramic particles, which could significantly refine and strengthen a weld joint.

In some embodiments of the present disclosure, the flux core includes, in mass percentage, 1.0% to 5.4%, preferably 1.1% to 5.0% of the ZrO₂. In the present disclosure, the ZrO₂ could react in situ with the metal powder in the weldment during welding to generate the nano-ceramic particles, which could significantly refine and strengthen the weld joint.

In some embodiments of the present disclosure, the flux core includes, in mass percentage, 1.1% to 5.7%, preferably 1.1% to 5.0% of the TiO₂. In the present disclosure, the TiO₂ could react in situ with the metal powder in the weldment during welding to generate the nano-ceramic particles, which could significantly refine and strengthen the weld joint.

In some embodiments of the present disclosure, the flux core includes, in mass percentage, 0.10% to 1.0%, preferably 0.3% to 1.0% of the powder. In some embodiments of the present disclosure, the powder is at least one selected from the group consisting of Sc, Er, and Zr, and is preferably selected from the group consisting of a mixed powder of the Sc and the Zr, and a mixed powder of the Er and the Zr. In some embodiments of the present disclosure, a mass ratio of the Sc to the Zr in the mixed powder of the Sc and the Zr is 1:2; and a mass ratio of the Er to the Zr in the mixed powder of the Er and the Zr is 2:1. In the present disclosure, the powder has desirable wettability with the aluminum and could adhere to surfaces of ZrB₂, TiB₂, and Al₂O₃ synthesized in situ during the welding, improving the wettability between the nano-ceramic particles and aluminum, thereby obtaining more uniformly-distributed nanoparticles. Meanwhile, rare earth aluminide phases could also significantly refine and strengthen the weld joint, thereby improving welding performance of the welding wire.

In some embodiments of the present disclosure, the flux core includes, in mass percentage, 0.8% to 1.2%, preferably 1.0% to 1.2% of the Mg. In the present disclosure, the Mg, as a component of the base metal of 6XXX series aluminum alloys, is more suitable for the welding of the base metal of 6XXX series aluminum alloys.

In some embodiments of the present disclosure, the flux core includes, in mass percentage, 0.4% to 1.2%, preferably 0.6% to 1.0% of the Si. In the present disclosure, the Si, as a component of the base metal of 6XXX series aluminum alloys, is more suitable for the welding of the base metal of 6XXX series aluminum alloys.

In some embodiments of the present disclosure, the flux core includes, in mass percentage, 0.1% to 0.4%, preferably 0.1% to 0.2% of the Cu in mass percentage. In the present disclosure, the Cu, as a component of the base metal of 6XXX series aluminum alloys, is more suitable for the welding of the base metal of 6XXX series aluminum alloys.

In some embodiments of the present disclosure, the flux core includes, in mass percentage, 0.04% to 0.35%, preferably 0.1% to 0.30% of the Cr. In the present disclosure, the Cr, as a component of the base metal of 6XXX series aluminum alloys, is more suitable for the welding of the base metal of 6XXX series aluminum alloys.

In some embodiments of the present disclosure, the flux core includes, in mass percentage, 0.15% to 0.25%, preferably 0.20% to 0.25% of the Zn. In the present disclosure, the Zn, as a component of the base metal of 6XXX series aluminum alloys, is more suitable for the welding of the base metal of 6XXX series aluminum alloys.

In some embodiments of the present disclosure, the flux core includes the aluminum powder as a balance in mass percentage. In the present disclosure, the aluminum powder is a matrix material.

In another technical solution of the present disclosure, the flux core includes the following components in mass percentage: 1.7% to 8.1% of the B₂O₃, 1.0% to 5.4% of the ZrO₂, 1.10% to 5.7% of the TiO₂, 0.10% to 1.0% of the powder, 4.0% to 8.0% of the Zn, 1.0% to 3.5% of the Mg, 0% to 2.5% of the Cu, and the aluminum powder as a balance. The welding wire made of the flux core provided by the present disclosure is suitable for welding the base metal of 7XXX series aluminum alloys in the fields of aerospace and rail transportation.

In some embodiments of the present disclosure, the flux core includes, in mass percentage, 1.7% to 8.1%, preferably 2.0% to 8.1%, more preferably 3.0% to 7.0%, and even more preferably 4.0% to 5.0% of the B₂O₃. In the present disclosure, the B₂O₃ could react in situ with the metal powder in the weldment during welding to generate the nano-ceramic particles, which could significantly refine and strengthen the weld joint.

In some embodiments of the present disclosure, the flux core includes, in mass percentage, 1.0% to 5.4%, preferably 1.1% to 5.4% of the ZrO₂. In the present disclosure, the ZrO₂ could react in situ with the metal powder in the weldment during welding to generate the nano-ceramic particles, which could significantly refine and strengthen the weld joint.

In some embodiments of the present disclosure, the flux core includes, in mass percentage, 1.10% to 5.7%, preferably 1.5% to 5.0% of the TiO₂. In the present disclosure, the TiO₂ could react in situ with the metal powder in the weldment during welding to generate the nano-ceramic particles, which could significantly refine and strengthen the weld joint.

In some embodiments of the present disclosure, the flux core includes, in mass percentage, 0.1% to 1.0%, preferably 0.45% to 0.6% of the powder. In some embodiments of the present disclosure, the powder is at least one selected from the group consisting of Sc, Er, and Zr, and is preferably selected from the group consisting of a mixed powder of the Sc and the Zr or a mixed powder of the Er and the Zr. In some embodiments of the present disclosure, a mass ratio of the Sc to the Zr in the mixed powder of the Sc and the Zr is 1:2; and a mass ratio of the Er to the Zr in the mixed powder of the Er and the Zr is 2:1. In the present disclosure, the powder has desirable wettability with the aluminum and could adhere to the surfaces of ZrB₂, TiB₂, and Al₂O₃ synthesized in situ during the welding, improving the wettability between the nano-ceramic particles and aluminum, thereby obtaining more uniformly-distributed nanoparticles. Meanwhile, rare earth aluminide phases could also significantly refine and strengthen the weld joint, thereby improving the welding performance of the welding wire.

In some embodiments of the present disclosure, the flux core includes, in mass percentage, 4.0% to 8.0%, preferably 6.0% to 7.6% of the Zn. In the present disclosure, the Zn, as a component of the base metal of 7XXX series aluminum alloys, is more suitable for the welding of the base metal of 7XXX series aluminum alloys.

In some embodiments of the present disclosure, the flux core includes, in mass percentage, 1.0% to 3.5%, preferably 1.6% to 2.4% of the Mg. In the present disclosure, the Mg, as a component of the base metal of 7XXX series aluminum alloys, is more suitable for the welding of the base metal of 7XXX series aluminum alloys.

In some embodiments of the present disclosure, the flux core includes, in mass percentage, 0% to 2.5%, preferably 1.4% to 2.0% of the Cu. In the present disclosure, the Cu, as a component of the base metal of 7XXX series aluminum alloys, is more suitable for the welding of the base metal of 7XXX series aluminum alloys.

In some embodiments of the present disclosure, the flux core includes the aluminum powder as a balance in mass percentage. In the present disclosure, the aluminum powder is a matrix material.

In some embodiments of the present disclosure, the B₂O₃, ZrO₂, and TiO₂ have independently a particle size of less than 5 μm; the Mg, Si, Cu, Cr, Zn, and powder have independently a particle size of less than 30 μm; and the aluminum powder has a particle size of less than 10 μm.

In some embodiments of the present disclosure, each of the components in the flux core have independently a purity of greater than 99.9%.

In the present disclosure, there is no special limitation on sources of each component in the flux core, and commercially-available products well known to those skilled in the art may be adopted.

In some embodiments of the present disclosure, the flux core has a filling rate of 5% to 34%, and preferably 10% to 20%.

In the present disclosure, the in-situ nanoparticle-reinforced aluminum-based welding wire further includes a coating. In some embodiments of the present disclosure, the coating is prepared by using a 1070 semi-hard pure aluminum strip. In some embodiments of the present disclosure, the coating has a thickness of 0.1 mm to 0.2 mm. There is no special limitation on a source of the coating, and commercially-available products well known to those skilled in the art may be adopted.

In the present disclosure, the in-situ nanoparticle-reinforced aluminum-based welding wire further includes a protective layer. In some embodiments of the present disclosure, the protective layer is composed of SiC and Al₂O₃. In some embodiments of the present disclosure, a mass ratio of the SiC to the Al₂O₃ is in a range of 3:1 to 3:2. In some embodiments of the present disclosure, the protective layer has a thickness of 0.1 mm to 0.2 mm. In the present disclosure, the SiC and Al₂O₃ selected for the protective layer have excellent wear resistance and oxidation resistance, as well as desirable microwave absorption properties.

In some embodiments of the present disclosure, the in-situ nanoparticle-reinforced aluminum-based welding wire has a diameter of 1 mm to 3 mm.

In the present disclosure, the aluminum-based welding wire is suitable for high-temperature welding. Under a high temperature condition of welding, ceramic powder components B₂O₃, ZrO₂, and TiO₂ in the flux core react in situ with a metal powder in a weldment to generate ternary nano-ceramic particles of ZrB₂, TiB₂, and Al₂O₃. The TiB₂ and ZrB₂ are hexagonal metalloid compounds with excellent thermodynamic stability, high melting point and elastic modulus, and desirable high-temperature strength. Al₂O₃ particles are very stable in size, have high hardness and desirable chemical compatibility with the matrix, and do not undergo interfacial chemical reactions. Multi-component nanoparticles reinforcement phases interact with each other and have a synergistic effect. The multi-component nanoparticles are more refined and strengthened than single nanoparticles. Meanwhile, the ZrB₂, the TiB₂, and the Al₂O₃ are desirable high-temperature absorption materials, and could generate active sites on surfaces of the ceramic particles during the welding, making it easier for Sc, Er, and Zr that have desirable wettability with aluminum to adhere to the surfaces of the ceramic particles, thereby improving the wettability between the nano-ceramic particles and aluminum to obtain more uniformly-distributed nanoparticles. In addition, rare earth aluminide phases could also significantly refine and strengthen the weld joint, thereby improving the welding performance of the wire and in turn making obtained welded plates achieve excellent mechanical properties.

The present disclosure further provides a method for preparing the in-situ nanoparticle-reinforced aluminum-based welding wire described in the above technical solutions, including the following steps:
(1) rolling the coating into a U-shaped groove, filling the U-shaped groove with the flux core, and then sealing the U-shaped groove to obtain a semi-finished product; and
(2) coating the protective layer on an outer layer of the semi-finished product obtained in step (1), and then conducting wire drawing to obtain the in-situ nanoparticle-reinforced aluminum-based welding wire.

In the present disclosure, the coating is rolled into a U-shaped groove, the U-shaped groove is filled with the flux core, and then the U-shaped groove is sealed to obtain a semi-finished product.

In some embodiments of the present disclosure, an oxide film on a surface of the coating is removed with sandpaper before use of the coating. There are no special limitations on operations of removing the oxide film on the surface of the coating with sandpaper, and the operations well known to those skilled in the art may be adopted.

In the present disclosure, there are no special limitations on operations of rolling the coating into the U-shaped groove, filling the U-shaped groove with the flux core, and then sealing the U-shaped groove, and the operations well known to those skilled in the art may be adopted.

In the present disclosure, the protective layer is coated on an outer layer of the semi-finished product, and then wire drawing is conducted to obtain the in-situ nanoparticle-reinforced aluminum-based welding wire.

In the present disclosure, there is no special limitation on a process for preparing the protective layer, and operations well known to those skilled in the art may be adopted.

In the present disclosure, there are no special limitations on operations of covering the outer layer of the semi-finished product with the protective layer, and the operations well known to those skilled in the art may be adopted.

In some embodiments of the present disclosure, the wire drawing is conducted at a temperature of 350° C. to 400° C. and a speed of 3 m/min to 5 m/min.

The method provided by the present disclosure has a simple process.

The present disclosure further provides a welding method of the in-situ nanoparticle-reinforced aluminum-based welding wire described in the technical solutions or an in-situ nanoparticle-reinforced aluminum-based welding wire prepared by the method described in the technical solutions, including conducting laser welding assisted by a microwave, dual magnetic fields, and an ultrasonic field simultaneously. In the present disclosure, the welding method generates active sites on the surfaces of the nano-ceramic particles by using the characteristics of low-temperature fast firing, selective heating, and non-contact heating in microwave, thereby promoting the adsorption of rare earth elements on the surfaces of the nano-ceramic particles to improve the wettability between the nano-ceramic particles and aluminum. At the same time, the welding method uses the coupling effect of magnetic field electromagnetic force and high-energy ultrasonic waves to promote the heat transfer and flow of an aluminum liquid in a molten pool, which could effectively improve the distribution of nanoparticles and suppress the occurrence of welding cracks.

In some embodiments of the present disclosure, the microwave has an output frequency of 2.45 GHz. In some embodiments of the present disclosure, the microwave has an output power of 0 kW to 3 kW, and preferably 0.4 kW to 0.5 kW.

In some embodiments of the present disclosure, the dual magnetic fields are an alternating magnetic field and a constant magnetic field. In some embodiments of the present disclosure, the alternating magnetic field has an exciting current of 250 A to 300 A, and preferably 280 A to 300 A. In some embodiments of the present disclosure, the alternating magnetic field has a frequency of 10 Hz to 12 Hz. In some embodiments of the present disclosure, the constant magnetic field has a magnetic field intensity of 0.1 T to 0.3 T, and preferably 0.2 T to 0.3 T. In the present disclosure, the distribution of the nanoparticles could be further improved by controlling process parameters of the dual magnetic fields, thereby further suppressing the occurrence of the welding cracks.

In some embodiments of the present disclosure, a magnetic field isolation plate is provided between the alternating magnetic field and the constant magnetic field; the constant magnetic field is applied at a trailing edge of the molten pool; the constant magnetic field has a direction opposite to a flow direction of the molten pool.

In some embodiments of the present disclosure, the ultrasonic field has an ultrasonic power of 5 kW to 10 kW, and preferably 8 kW to 10 kW. In some embodiments of the present disclosure, the ultrasonic field has an ultrasonic frequency of 20 kHz to 30 kHz, and preferably 25 kHz to 28 kHz. In some embodiments of the present disclosure, the ultrasonic field is applied to a back side of the weld joint. In some embodiments of the present disclosure, an ultrasonic vibrator used in the ultrasonic field is on a straight line of the weld joint.

In some embodiments of the present disclosure, a laser beam of the laser welding assisted by the microwave, the dual magnetic fields, and the ultrasonic field simultaneously is on the straight line of the weld joint. In some embodiments of the present disclosure, a distance between the laser beam and the ultrasonic vibrator is 10 mm to 20 mm, and preferably 15 mm. In some embodiments of the present disclosure, the laser welding has a power of 0.2 kW to 1.5 kW, and preferably 0.4 kW to 1.2 kW.

In some embodiments of the present disclosure, the laser beam is ring-shaped and central beam-shaped. In some embodiments of the present disclosure, during the welding, positions of the laser beam, the microwave, the dual magnetic fields, and the ultrasonic vibrator are fixed, and the base metal is moved. In some embodiments of the present disclosure, the laser welding is conducted at a speed of 200 mm/min to 500 mm/min, and preferably 450 mm/min to 480 mm/min. In the present disclosure, the shape of the laser beam could be controlled to avoid vaporization of the central material due to excessive temperature.

In some embodiments of the present disclosure, the laser welding assisted by the microwave, the dual magnetic fields, and the ultrasonic field simultaneously is conducted in a protective gas. In some embodiments of the present disclosure, the protective gas is argon. In some embodiments of the present disclosure, the argon has a purity of 99.99%.

In some embodiments of the present disclosure, in the weld joint obtained by laser welding assisted by the microwave, the dual magnetic fields, and the ultrasonic field simultaneously, a molar ratio of the B₂O₃ to the ZrO₂ is 1:1, and a molar ratio of the B₂O₃ to the TiO₂ is 1:1; the ZrB₂ nanoparticles in the weld joint account for 1% to 5% of a mass of the in-situ nanoparticle-reinforced aluminum-based welding wire; the TiB₂ nanoparticles in the weld joint account for 1% to 5% of a mass of the in-situ nanoparticle-reinforced aluminum-based welding wire; the Al₂O₃ nanoparticles in the weld joint account for 3.9% to 19.6% of a mass of the in-situ nanoparticle-reinforced aluminum-based welding wire.

FIG. 1 shows a schematic structural diagram of a device for the laser welding assisted by the microwave, the dual magnetic fields, and the ultrasonic field simultaneously in an embodiment of the present disclosure; where 1 refers to a microwave generator, 2 refers to an alternating electromagnetic field power supply, 3 refers to a constant electromagnetic field power supply, 4 refers to an ultrasonic transmitter, 5 refers to a laser welded joint, 6 refers to a microwave transmitter, 7 refers to an alternating electromagnetic field coil, 8 refers to a magnetic field isolation plate, 9 refers to a constant electromagnetic field coil, 10 refers to the in-situ nanoparticle-reinforced aluminum-based welding wire, 11 refers to a welded plate, and 12 refers to an ultrasonic horn.

FIG. 1 clearly shows a positional relationship of each component during the laser welding assisted by the microwave, the dual magnetic fields, and the ultrasonic field simultaneously.

In the present disclosure, in order to improve the weldability of aluminum alloy, welding wire technology and in-situ synthesis technology are organically combined. The laser heat directly induces the in-situ reaction between the reactive powder in the welding wire and the weldment to synthesize the nano-ceramic particles. In addition, the laser welding assisted by the microwave, the dual magnetic fields, and the ultrasonic field simultaneously is conducted to promote the heat transfer and flow of the aluminum liquid in the molten pool to form a relatively-uniform temperature field, regulating the nucleation, growth, and distribution of nanoparticles, and promoting the escape of air bubbles. In this way, the occurrence of welding defects is suppressed, a forming quality of the weld joint in laser welding is improved, and a joint with excellent mechanical properties is obtained.

In the present disclosure, the laser welding assisted by the microwave, the dual magnetic fields, and the ultrasonic field simultaneously is conducted, the alternating magnetic field, that is, a coupling effect of electromagnetic stirring, magnetic field electromagnetic force, and high-energy ultrasonic waves promotes the heat transfer and flow of the aluminum liquid in the molten pool. As a result, the relatively-uniform temperature field is formed, and improves the distribution of the nanoparticles, facilitates the floating and escaping of the air bubbles, and inhibits the occurrence of the welding cracks. In addition, when a constant magnetic field is applied, a direction of the Loren magnetic force generated is always opposite to a direction of the molten pool flow, inhibiting the flow of the molten pool and reducing a solidification rate of the molten pool, thereby assisting the coupling of the alternating magnetic field and the ultrasonic field on the molten pool.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts shall fall within the scope of the present disclosure.

### Example 1

An in-situ nanoparticle-reinforced aluminum-based welding wire consisted of a flux core, a coating, and a protective layer that were arranged in sequence from inside to outside; where
the flux core consisted of the following components in mass percentage: 1.7% of B₂O₃, 1.10% of ZrO₂, 1.1% of TiO₂, 0.10% of a Sc powder, 0.2% of a Zr powder, 1.2% of a Mg powder, 1.0% of a Si powder, 0.1% of a Cu powder, 0.1% of a Cr powder, 0.2% of a Zn powder, and an aluminum powder as a balance.

The B₂O₃, ZrO₂, and TiO₂ each had a particle diameter of less than 5 μm. The Mg powder, Si powder, Cu powder, Cr powder, Zn powder, Sc powder, and Zr powder each had a particle diameter of less than 30 μm. The aluminum powder had a particle size of less than 10 μm. Each component in the flux core had a purity of greater than 99.9%.

The flux core had a filling rate of 6.8%.

The coating was a 1070 pure aluminum strip with a thickness of 0.1 mm.

A flux core layer (composed of the flux core and the coating) had a diameter of 1 mm.

The protective layer was composed of SiC and Al₂O₃. A mass ratio of the SiC to the Al₂O₃ was 3:1. The protective layer had a thickness of 0.15 mm.

A method for preparing the in-situ nanoparticle-reinforced aluminum-based welding wire was conducted as follows.
(1) An oxide film on a surface of the coating was removed with sandpaper, the coating was rolled into a U-shaped groove, the U-shaped groove was filled with the flux core, and then the U-shaped groove was sealed to obtain a semi-finished product.
(2) The protective layer was coated on an outer layer of the semi-finished product obtained in step (1), and then wire drawing was conducted at 350° C. and a speed of 3 m/min to obtain the in-situ nanoparticle-reinforced aluminum-based welding wire.

### Use Example 1

The in-situ nanoparticle-reinforced aluminum-based welding wire prepared in Example 1 and a 6082 aluminum alloy weldment were subjected to laser welding assisted by a microwave, dual magnetic fields, and an ultrasonic field simultaneously, with welding process parameters as follows:

A laser beam was in a ring+central beam shape. During the welding, positions of the laser beam, microwave, dual magnetic fields, and an ultrasonic vibrator were fixed, while the 6082 aluminum alloy weldment was moved, and argon with a purity of 99.99% was applied to both front and back of the weldment. The laser welding was conducted at a power 0.8 kW and a welding rate of 480 mm/min. The microwave had an output frequency of 2.45 GHz and an output power of 0.4 kW. An alternating magnetic field had an exciting current of 250 A and a frequency of 10 Hz. A constant magnetic field had a magnetic field intensity of 0.3 T. A magnetic field isolation plate was provided between the alternating magnetic field and the constant magnetic field. An ultrasonic field was applied to a back side of a weld joint. The laser beam and the ultrasonic vibrator were both on a straight line of the weld joint with a distance set to 15 mm, and an ultrasonic power was 8 kW while an ultrasonic frequency was 20 kHz.

The mass contents of ZrB₂, TiB₂, and Al₂O₃ particles in the weld joint were 1%, 1% and 3.9%, respectively.

### Example 2

An in-situ nanoparticle-reinforced aluminum-based welding wire consisted of a flux core, a coating, and a protective layer that were arranged in sequence from inside to outside; where
the flux core consisted of the following components in mass percentage: 4.9% of B₂O₃, 3.3% of ZrO₂, 3.4% of TiO₂, 0.150% of a Sc powder, 0.3% of a Zr powder, 1.2% of a Mg powder, 0.6% of a Si powder, 0.2% of a Cu powder, 0.1% of a Cr powder, 0.25% of a Zn powder, and an aluminum powder as a balance.

The B₂O₃, ZrO₂, and TiO₂ each had a particle diameter of less than 5 μm. The Mg powder, Si powder, Cu powder, Cr powder, Zn powder, Sc powder, and Zr powder each had a particle diameter of less than 30 μm. The aluminum powder had a particle size of less than 10 μm. Each component in the flux core had a purity of greater than 99.9%.

The flux core had a filling rate of 14.4%.

The coating was a 1070 pure aluminum strip with a thickness of 0.1 mm.

A flux core layer (composed of the flux core and the coating) had a diameter of 1 mm.

The protective layer was composed of SiC and Al₂O₃. A mass ratio of the SiC to the Al₂O₃ was 3:1. The protective layer had a thickness of 0.15 mm.

A method for preparing the in-situ nanoparticle-reinforced aluminum-based welding wire was conducted as follows.
(1) An oxide film on a surface of the coating was removed with sandpaper, the coating was rolled into a U-shaped groove, the U-shaped groove was filled with the flux core, and then the U-shaped groove was sealed to obtain a semi-finished product.
(2) The protective layer was coated on an outer layer of the semi-finished product obtained in step (1), and then wire drawing was conducted at 380° C. and a speed of 4 m/min to obtain the in-situ nanoparticle-reinforced aluminum-based welding wire.

### Use Example 2

The in-situ nanoparticle-reinforced aluminum-based welding wire prepared in Example 2 and a 6061 aluminum alloy weldment were subjected to laser welding assisted by a microwave, dual magnetic fields, and an ultrasonic field simultaneously, with welding process parameters as follows:

A laser beam was in a ring+central beam shape. During the welding, positions of the laser beam, microwave, dual magnetic fields, and an ultrasonic vibrator were fixed, while the 6061 aluminum alloy weldment was moved, and argon with a purity of 99.99% was applied to both front and back of the weldment. The laser welding was conducted at a power 0.8 kW and a welding rate of 480 mm/min. The microwave had an output frequency of 2.45 GHz and an output power of 0.4 kW. An alternating magnetic field had an exciting current of 280 A and a frequency of 12 Hz. A constant magnetic field had a magnetic field intensity of 0.3 T. A magnetic field isolation plate was provided between the alternating magnetic field and the constant magnetic field. An ultrasonic field was applied to a back side of a weld joint. The laser beam and the ultrasonic vibrator were both on a straight line of the weld joint with a distance set to 15 mm, and an ultrasonic power was 10 kW while an ultrasonic frequency was 25 kHz.

The mass contents of ZrB₂, TiB₂, and Al₂O₃ particles in the weld joint were 3%, 3% and 11.8%, respectively.

### Example 3

An in-situ nanoparticle-reinforced aluminum-based welding wire consisted of a flux core, a coating, and a protective layer that were arranged in sequence from inside to outside; where
the flux core consisted of the following components in mass percentage: 8.10% of B₂O₃, 5.4% of ZrO₂, 5.7% of TiO₂, 0.3% of a Er powder, 0.15% of a Zr powder, 2.4% of a Mg powder, 2.0% of a Cu powder, 6.0% of a Zn powder, and an aluminum powder as a balance.

The B₂O₃, ZrO₂, and TiO₂ each had a particle diameter of less than 5 μm. The Mg powder, Cu powder, Zn powder, Er powder and Zr powder each had a particle diameter of less than 30 μm. The aluminum powder had a particle size of less than 10 μm. Each component in the flux core had a purity of greater than 99.9%.

The flux core had a filling rate of 30.05%.

The coating was a 1070 pure aluminum strip with a thickness of 0.1 mm.

A flux core layer (composed of the flux core and the coating) had a diameter of 1 mm.

The protective layer was composed of SiC and Al₂O₃. A mass ratio of the SiC to the Al₂O₃ was 3:2. The protective layer had a thickness of 0.15 mm.

A method for preparing the in-situ nanoparticle-reinforced aluminum-based welding wire was conducted as follows.
(1) An oxide film on a surface of the coating was removed with sandpaper, the coating was rolled into a U-shaped groove, the U-shaped groove was filled with the flux core, and then the U-shaped groove was sealed to obtain a semi-finished product.
(2) The protective layer was coated on an outer layer of the semi-finished product obtained in step (1), and then wire drawing was conducted at 400° C. and a speed of 5 m/min to obtain the in-situ nanoparticle-reinforced aluminum-based welding wire.

### Use Example 3

The in-situ nanoparticle-reinforced aluminum-based welding wire prepared in Example 3 and a 7050 aluminum alloy weldment were subjected to laser welding assisted by a microwave, dual magnetic fields, and an ultrasonic field simultaneously, with welding process parameters as follows:

A laser beam was in a ring+central beam shape. During the welding, positions of the laser beam, microwave, dual magnetic fields, and an ultrasonic vibrator were fixed, while the 7050 aluminum alloy weldment was moved, and argon with a purity of 99.99% was applied to both front and back of the weldment. The laser welding was conducted at a power 0.8 kW and a welding rate of 480 mm/min. The microwave had an output frequency of 2.45 GHz and an output power of 0.4 kW. An alternating magnetic field had an exciting current of 300 A and a frequency of 12 Hz. A constant magnetic field had a magnetic field intensity of 0.3 T. A magnetic field isolation plate was provided between the alternating magnetic field and the constant magnetic field. An ultrasonic field was applied to a back side of a weld joint. The laser beam and the ultrasonic vibrator were both on a straight line of the weld joint with a distance set to 15 mm, and an ultrasonic power was 10 kW while an ultrasonic frequency was 28 kHz.

The mass contents of ZrB₂, TiB₂, and Al₂O₃ particles in the weld joint were 5%, 5% and 19.6%, respectively.

### Example 4

An in-situ nanoparticle-reinforced aluminum-based welding wire consisted of a flux core, a coating, and a protective layer that were arranged in sequence from inside to outside; where
the flux core consisted of the following components in mass percentage: 1.7% of B₂O₃, 1.1% of ZrO₂, 1.1% of TiO₂, 0.4% of a Er powder, 0.2% of a Zr powder, 1.6% of a Mg powder, 1.4% of a Cu powder, 7.6% of a Zn powder, and an aluminum powder as a balance;

The B₂O₃, ZrO₂, and TiO₂ each had a particle diameter of less than 5 μm. The Mg powder, Cu powder, Zn powder, Er powder and Zr powder each had a particle diameter of less than 30 μm. The aluminum powder had a particle size of less than 10 μm. Each component in the flux core had a purity of greater than 99.9%.

The flux core had a filling rate of 15%.

The coating was a 1070 pure aluminum strip with a thickness of 0.1 mm.

A flux core layer (composed of the flux core and the coating) had a diameter of 1 mm.

The protective layer was composed of SiC and Al₂O₃. A mass ratio of the SiC to the Al₂O₃ was 3:2. The protective layer had a thickness of 0.15 mm.

A method for preparing the in-situ nanoparticle-reinforced aluminum-based welding wire was conducted as follows.
(1) An oxide film on a surface of the coating was removed with sandpaper, the coating was rolled into a U-shaped groove, the U-shaped groove was filled with the flux core, and then the U-shaped groove was sealed to obtain a semi-finished product.
(2) The protective layer was coated on an outer layer of the semi-finished product obtained in step (1), and then wire drawing was conducted at 400° C. and a speed of 5 m/min to obtain the in-situ nanoparticle-reinforced aluminum-based welding wire.

### Use Example 4

The in-situ nanoparticle-reinforced aluminum-based welding wire prepared in Example 4 and a 7085 aluminum alloy weldment were subjected to laser welding assisted by a microwave, dual magnetic fields, and an ultrasonic field simultaneously, with welding process parameters as follows:

A laser beam was in a ring+central beam shape. During the welding, positions of the laser beam, microwave, dual magnetic fields, and an ultrasonic vibrator were fixed, while the 7085 aluminum alloy weldment was moved, and argon with a purity of 99.99% was applied to both front and back of the weldment. The laser welding was conducted at a power 0.8 kW and a welding rate of 480 mm/min. The microwave had an output frequency of 2.45 GHz and an output power of 0.4 kW. An alternating magnetic field had an exciting current of 300 A and a frequency of 12 Hz. A constant magnetic field had a magnetic field intensity of 0.3 T. A magnetic field isolation plate was provided between the alternating magnetic field and the constant magnetic field. An ultrasonic field was applied to a back side of a weld joint. The laser beam and the ultrasonic vibrator were both on a straight line of the weld joint with a distance set to 15 mm, and an ultrasonic power was 10 kW while an ultrasonic frequency was 30 kHz.

The mass contents of ZrB₂, TiB₂, and Al₂O₃ particles in the weld joint were 1%, 1% and 3.9%, respectively.

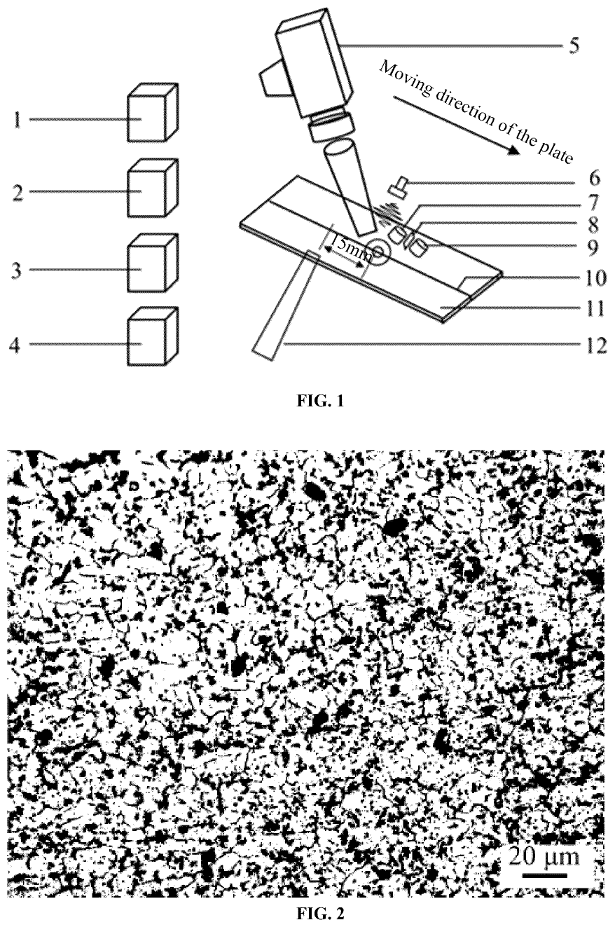

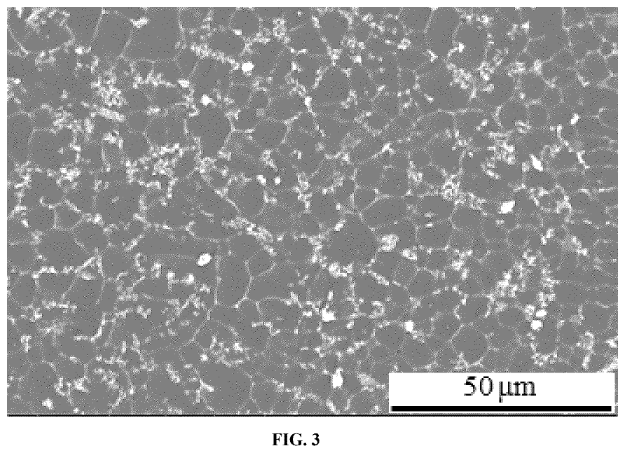

FIG. 2 shows an OM image of the weld joint prepared in Use Example 4; and FIG. 3 shows an SEM image of the weld joint prepared in Use Example 4.

As shown in FIG. 2 and FIG. 3, the nanoparticles in the weld joint are evenly distributed in the matrix, and could effectively refine grains and strengthen the weld joint.

Laser welded joints prepared in Use Examples 1 to 4 were subjected to a room-temperature tensile test in accordance with ASTM E8M-09 experimental standards, and comparative tests were conducted with laser welded joints obtained by direct laser butt welding of 6082, 6061, 7050, and 7085 aluminum alloys without external field assistance. The results are shown in Table 1.

TABLE 1
Mechanical property indicators of laser welded joints in welded state

| Test No. | Tensile strength (MPa) | Elongation (%) | Joint coefficient (%) |
|---|---|---|---|
| 6082 | 237 | 10.8 | 74 |
| 6061 | 226 | 11.2 | 78 |
| 7050 | 342 | 8.2 | 67 |
| 7085 | 314 | 8.5 | 64 |
| Use Example 1 | 323 | 14.7 | 85 |
| Use Example 2 | 308 | 15.3 | 88 |
| Use Example 3 | 452 | 11.5 | 78 |
| Use Example 4 | 426 | 11.8 | 76 |

As shown in Table 1, compared with those of the direct laser butt welding of 6082, 6061, 7050, and 7085 aluminum alloys without external field assistance, the tensile strength, elongation, and joint coefficient of the laser welded joints in the use examples have been significantly improved. This indicates that an essence of the present disclosure is based on in-situ endogenous nanoparticles and rare earth precipitation phases evenly distributed in the matrix, which could effectively refine the grains, greatly alleviate welding hot cracks, and significantly improve the mechanical properties of the joint. Specifically, the generation and distribution of nano-reinforced phases are controlled through the coupling of the microwave, dual magnetic fields, and ultrasonic field, such that they could effectively play the role of refinement and strengthening.

The above descriptions of embodiments are merely provided to help understand the method of the present disclosure and a core idea thereof. It should be noted that a person of ordinary skill in the art may further make several improvements and modifications without departing from the principle of the present disclosure, but such improvements and modifications should also fall within the protection scope of the present disclosure. Various amendments to these embodiments are apparent to those of professional skill in the art, and the general principles defined herein may be implemented in other embodiments without departing from the spirit or scope of the present disclosure. Accordingly, the present disclosure will not be limited to these examples shown herein, but is to fall within the widest scope consistent with the principles and novel features disclosed herein.

1. An in-situ nanoparticle-reinforced aluminum-based welding wire, comprising a flux core, a coating, and a protective layer that are arranged in sequence from inside to outside; wherein
the flux core comprises the following components in mass percentage: 1.7% to 8.1% of B₂O₃, 1.0% to 5.4% of ZrO₂, 1.1% to 5.7% of TiO₂, 0.1% to 1.0% of a powder, 0.8% to 1.2% of Mg, 0.4% to 1.2% of Si, 0.1% to 0.4% of Cu, 0.04% to 0.35% of Cr, 0.15% to 0.25% of Zn, and an aluminum powder as a balance; alternatively,
the flux core comprises the following components in mass percentage: 1.7% to 8.1% of B₂O₃, 1.0% to 5.4% of ZrO₂, 1.1% to 5.7% of TiO₂, 0.1% to 1.0% of a powder, 4.0% to 8.0% of Zn, 1.0% to 3.5% of Mg, 0% to 2.5% of Cu, and an aluminum powder as a balance; and
the powder is at least one selected from the group consisting of Sc, Er, and Zr.

2. The in-situ nanoparticle-reinforced aluminum-based welding wire of claim 1, wherein the flux core comprises the following components in mass percentage: 2.0% to 8.0% of the B₂O₃, 1.1% to 5.0% of the ZrO₂, 1.1% to 5.0% of the TiO₂, 0.3% to 1.0% of the powder, 1.0% to 1.2% of the Mg, 0.6% to 1.0% of the Si, 0.1% to 0.2% of the Cu, 0.1% to 0.30% of the Cr, 0.20% to 0.25% of the Zn, and the aluminum powder as a balance.

3. The in-situ nanoparticle-reinforced aluminum-based welding wire of claim 1, wherein the flux core comprises the following components in mass percentage: 2.0% to 8.1% of the B₂O₃, 1.1% to 5.4% of the ZrO₂, 1.5% to 5.0% of the TiO₂, 0.45% to 0.6% of the powder, 1.6% to 2.4% of the Mg, 1.4% to 2.0% of the Cu, 6.0% to 7.6% of the Zn, and the aluminum powder as a balance.

4. The in-situ nanoparticle-reinforced aluminum-based welding wire of claim 1, wherein the powder is selected from the group consisting of a mixed powder of the Sc and the Zr, and a mixed powder of the Er and the Zr.

5. The in-situ nanoparticle-reinforced aluminum-based welding wire of claim 4, wherein a mass ratio of the Sc to the Zr in the mixed powder of the Sc and the Zr is 1:2; and a mass ratio of the Er to the Zr in the mixed powder of the Er and the Zr is 2:1.

6. The in-situ nanoparticle-reinforced aluminum-based welding wire of claim 1, wherein the flux core has a filling rate of 5% to 34%.

7. The in-situ nanoparticle-reinforced aluminum-based welding wire of claim 1, wherein the coating is prepared by using a 1070 semi-hard pure aluminum strip.

8. The in-situ nanoparticle-reinforced aluminum-based welding wire of claim 1, wherein the coating has a thickness of 0.1 mm to 0.2 mm.

9. The in-situ nanoparticle-reinforced aluminum-based welding wire of claim 1, wherein the protective layer is composed of SiC and Al₂O₃.

10. The in-situ nanoparticle-reinforced aluminum-based welding wire of claim 9, wherein a mass ratio of the SiC to the Al₂O₃ is in a range of 3:1 to 3:2.

11. The in-situ nanoparticle-reinforced aluminum-based welding wire of claim 1, wherein the protective layer has a thickness of 0.1 mm to 0.2 mm.

12. A method for preparing the in-situ nanoparticle-reinforced aluminum-based welding wire of claim 1, comprising the following steps:
(1) rolling the coating into a U-shaped groove, filling the U-shaped groove with the flux core, and then sealing the U-shaped groove to obtain a semi-finished product; and
(2) coating the protective layer on an outer layer of the semi-finished product obtained in step (1), and then conducting wire drawing to obtain the in-situ nanoparticle-reinforced aluminum-based welding wire.

13. A welding method of the in-situ nanoparticle-reinforced aluminum-based welding wire of claim 1, comprising conducting laser welding assisted by a microwave, dual magnetic fields, and an ultrasonic field simultaneously.

14. The welding method of claim 13, wherein the microwave has an output frequency of 2.45 GHz and an output power of 0 kW to 3 kW.

15. The welding method of claim 13, wherein the dual magnetic fields are an alternating magnetic field and a constant magnetic field; the alternating magnetic field has an exciting current of 250 A to 300 A and a frequency of 10 Hz to 12 Hz; and the constant magnetic field has a magnetic field intensity of 0.1 T to 0.3 T.

16. The welding method of claim 13, wherein the ultrasonic field has an ultrasonic power of 5 kW to 10 kW and an ultrasonic frequency of 20 kHz to 30 kHz.

17. The in-situ nanoparticle-reinforced aluminum-based welding wire of claim 7, wherein the coating has a thickness of 0.1 mm to 0.2 mm.

18. The in-situ nanoparticle-reinforced aluminum-based welding wire of claim 9, wherein the protective layer has a thickness of 0.1 mm to 0.2 mm.

19. The method of claim 12, wherein the flux core comprises the following components in mass percentage: 2.0% to 8.0% of the B₂O₃, 1.1% to 5.0% of the ZrO₂, 1.1% to 5.0% of the TiO₂, 0.3% to 1.0% of the powder, 1.0% to 1.2% of the Mg, 0.6% to 1.0% of the Si, 0.1% to 0.2% of the Cu, 0.1% to 0.30% of the Cr, 0.20% to 0.25% of the Zn, and the aluminum powder as a balance.

20. The method of claim 12, wherein the flux core comprises the following components in mass percentage: 2.0% to 8.1% of the B₂O₃, 1.1% to 5.4% of the ZrO₂, 1.5% to 5.0% of the TiO₂, 0.45% to 0.6% of the powder, 1.6% to 2.4% of the Mg, 1.4% to 2.0% of the Cu, 6.0% to 7.6% of the Zn, and the aluminum powder as a balance.
